(19) United States
(12) Patent Application Publication
(10) Pub. No.: US 2026/0136236 A1
(43) Pub. Date: May 14, 2026

(54) METHOD FOR DETERMINING RELAY BEARER CONFIGURATION AND TERMINAL DEVICE

(71) Applicant: GUANGDONG OPPO MOBILE TELECOMMUNICATIONS CORP., LTD., Dongguan (CN)

(72) Inventors: Boyuan ZHANG, Dongguan (CN); Qianxi LU, Dongguan (CN); Bingxue LENG, Dongguan (CN)

(21) Appl. No.: 18/945,240

(22) Filed: Nov. 12, 2024

(51) Int. Cl. H04W 28/02; H04W 76/20; H04W 92/18

(52) U.S. Cl. CPC H04W 28/0273; H04W 28/0268; H04W 76/20; H04W 92/18

(57) ABSTRACT

Provided is a method for determining a relay bearer configuration, which relates to the field of communication technologies. The method is applicable to a first terminal and includes: receiving a Sidelink Relay Adaptation Protocol (SRAP) message; and determining a target relay bearer configuration in a candidate relay bearer configuration list based on the SRAP message.

### CROSS-REFERENCE TO RELATED APPLICATION

This application is a continuation application of International Application No. PCT/CN2022/106556, filed on July 19, 2022, the disclosure of which is herein incorporated by reference in its entirety.

### TECHNICAL FIELD

Embodiments of the present disclosure relate to the field of communication technologies, and in particular, relate to a method and an apparatus for determining a relay bearer configuration, a device, and a storage medium.

### BACKGROUND

Device to device (D2D) communication is a sidelink communication technology, that is, near-field communication in which direct information connection is performed between terminals through a PC5 interface. D2D relay refers to the relay transmission of data for a source terminal and a remote terminal through a relay terminal, such that communication between the source terminal and the remote terminal is implemented.

### SUMMARY

Embodiments of the present disclosure provide a method for determining a relay bearer configuration and a terminal device. The technical solutions are as follows.

According to some embodiments of the present disclosure, a method for determining a relay bearer configuration is provided. The method is applicable to a first terminal, and the method includes:

receiving a Sidelink Relay Adaptation Protocol (SRAP) message; and

determining a target relay bearer configuration in a candidate relay bearer configuration list based on the SRAP message.

According to some embodiments of the present disclosure, a terminal device is provided. The terminal device includes a transceiver and a processor connected to the transceiver.

The transceiver is configured to receive a Sidelink Relay Adaptation Protocol (SRAP) message.

The processor is configured to determine a target relay bearer configuration in a candidate relay bearer configuration list based on the SRAP message.

### BRIEF DESCRIPTION OF THE DRAWINGS

For describing the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a communication system according to some embodiments of the present disclosure;

FIG. 2 is a flowchart of a method for determining a relay bearer configuration according to some embodiments of the present disclosure;

FIG. 3 is a flowchart of a method for determining a relay bearer configuration according to some embodiments of the present disclosure;

FIG. 4 is a flowchart of a method for determining a relay bearer configuration according to some embodiments of the present disclosure;

FIG. 5 is a schematic diagram of a serialization rule for generating a D2D bearer configuration sequence according to some embodiments of the present disclosure;

FIG. 6 is a structural block diagram of an apparatus for determining a relay bearer configuration according to some embodiments of the present disclosure; and

FIG. 7 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and business scenarios described in the embodiments of the present disclosure are intended to describe the technical solutions in the embodiments of the present disclosure more clearly, but do not constitute a limitation on the technical solutions according to the embodiments of the present disclosure. Those of ordinary skill in the art learn that, with the evolution of the network architecture and the emergence of new business scenarios, the technical solutions according to the embodiments of the present disclosure are also applicable to similar technical problems.

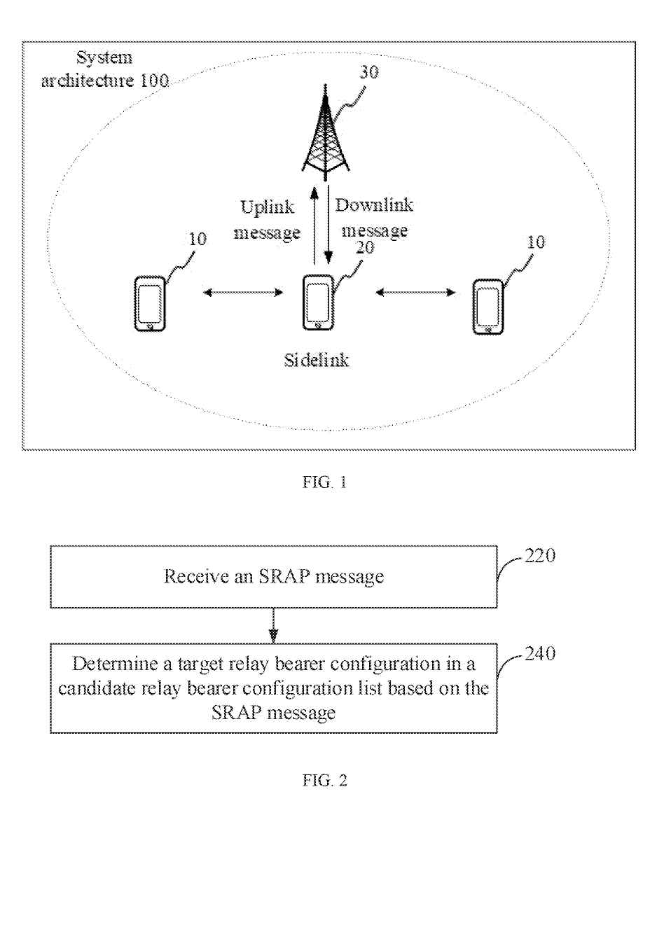

Referring to FIG. 1, a block diagram of a communication system according to some exemplary embodiments of the present disclosure is shown. The communication system includes a remote terminal 10, a relay terminal 20, and a network device 30.

The remote terminal 10 refers to a terminal device that performs sidelink communication with the relay terminal 20 and thus further communicates with other remote terminals 10 or the network device 30 via relay by the relay terminal 20. Two remote terminals 10 performing sidelink communication with each other via the relay terminal 20 may be referred to as a source terminal and a remote terminal, separately. For example, the source terminal transmits data to the remote terminal via the relay terminal 20, or vice versa. The number of remote terminals 10 is usually plural, and one or more remote terminals 10 may be distributed in a cell managed by each network device 30. The remote terminal 10 may include various handheld devices, vehicle-mounted devices, wearable devices, computing devices, or other processing devices connected to a radio modem with a wireless communication functionality, as well as various forms of user equipment, mobile stations (MSs), and the like. For convenience of description, the devices described above are collectively referred to as remote terminals.

The relay terminal 20 refers to a terminal device that can perform sidelink communication with the remote terminal 10. The number of relay terminals 20 is usually plural, and one or more relay terminals 20 may be distributed in a cell managed by each network device 30. The relay terminal 20 may include various handheld devices, vehicle-mounted devices, wearable devices, computing devices, or other processing devices connected to a radio modem with a wireless communication functionality, as well as various forms of user equipment, mobile stations (MSs), and the like. For convenience of description, the devices described above are collectively referred to as relay terminals.

The network device 30 is a device configured to provide a wireless communication function for the remote terminal 10 and the relay terminal 20. The network device 30 may include various forms of macro base stations, micro base stations, relay stations, access points, and the like. In systems using different radio access technologies, the name of the network device 30 may vary. For example, in a 5G new radio (NR) system, the network device is referred to as a 5G base station (5G Node B, gNodeB/gNB).

A connection between the remote terminal 10 and the relay terminal 20 is established through a sidelink, such that the remote terminal and the relay terminal communicate with each other through a direct communication interface (such as a PC5 interface), and the relay terminal 20 can broadcast a message of a network device to the remote terminal 10 through the sidelink, such that network relay is implemented. Communication data is directly transmitted between the remote terminal 10 and the relay terminal 20 through the sidelink, which is different from a conventional cellular system in which communication data is received or transmitted by network devices. The transmission has characteristics of short delay and low overhead, and is therefore suitable for communication between two terminals that are geographically close to each other (such as a vehicle-mounted device and another peripheral device that is geographically close to the vehicle-mounted device). The network device 30 and the relay terminal 20 communicate with each other over some air technology, such as a Uu interface.

Two transmission modes of D2D are defined in the 3rd Generation Partnership Project (3GPP). In mode A, a base station allocates resources for data transmission on the sidelink, while in mode B, the source terminal/remote terminal selects a resource from a resource pool for data transmission on the sidelink.

However, in the D2D relay transmission mode, the relay terminal cannot directly acquire a relay bearer configuration from a Sidelink Relay Adaptation Protocol (SRAP) message. How to determine the relay bearer configuration to further implement the D2D relay is a problem that needs to be solved.

In the embodiments of the present disclosure, the terminal device (including the remote terminal 10 and the relay terminal 20) support broadcast transmission of a discovery message, such that other terminal devices discover the terminal device by receiving the discovery message.

The technical solutions of the embodiments of the present disclosure are applicable to various communication systems, such as: a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolved system of the NR system, an LTE-based access to unlicensed spectrum (LTE-U) system, an NR-U system, a universal mobile telecommunication system (UMTS), worldwide interoperability for microwave access (WiMAX) communication system, wireless local area networks (WLANs), wireless fidelity (WiFi), a next-generation communication system, and other communication systems.

Generally, conventional communication systems support a limited number of connections and are easy to implement. However, with the development of communication technologies, mobile communication systems will support not only conventional communications, but also other communications, such as user equipment-user equipment (U2U) communications, device-to-device (D2D) communications, machine-to-machine (M2M) communications, machine-type communications (MTCs), vehicle-to-vehicle (V2V) communications, and vehicle-to-everything (V2X) communications. The embodiments of the present disclosure are also applicable to such communication systems.

In layer 2 D2D relay, the relay terminal performs quality of service (QoS) segmentation for the remote terminal. After the remote terminal transmits data to the relay terminal based on the segmented QoS, the relay terminal cannot directly determine a specific relay bearer configuration of the remote terminal based on information carried by the remote terminal on an SRAP message sub-header, and therefore, the relay terminal cannot determine a relay bearer configuration required for performing relay transmission.

In order to solve the above problem, in the technical solutions according to the present disclosure, information carried in an SRAP message is associated with the relay bearer configuration used for performing D2D relay transmission, and a first terminal determines a target relay bearer configuration for the relay transmission based on the received SRAP message, such that the D2D relay transmission is implemented.

In the embodiments of the present disclosure, layer 2 relay refers to a relay mode for implementing relay through an access stratum (AS) of the relay terminal.

The technical solutions of the present disclosure will be described below with reference to several embodiments.

Referring to FIG. 2, a flowchart of a method for determining a relay bearer configuration according to some embodiments of the present disclosure is shown. The method is applicable to a first terminal, which may be the relay terminal 20 or the remote terminal 10 in the communication system shown in FIG. 1. The method includes the following steps:

In step 220, an SRAP message is received.

In some embodiments, the SRAP message carries a bearer identifier (ID); or a QoS flow ID.

In some embodiments, information carried in a header of the SRAP message includes a terminal ID, a bearer ID, a QoS flow ID, a data/control identifier (D/C), and the like, which is not limited in the present disclosure.

In some embodiments, the bearer is configured to transmit data. One terminal transmits data through a plurality of bearers, with different bearers being identified by bearer IDs.

In some embodiments, the QoS flow ID or QoS flow ID list is carried in at least one of the following protocol layer sub-headers: an SRAP layer; a radio link control (RLC) layer; and a medium access control (MAC) layer.

In step 240, a target relay bearer configuration is determined in a candidate relay bearer configuration list based on the SRAP message.

In some embodiments, the SRAP message carries the bearer ID, such that the target relay bearer configuration is determined in the candidate relay bearer configuration list based on the bearer ID. In other embodiments, the SRAP message carries the QoS flow ID, such that the target relay bearer configuration is determined in the candidate relay bearer configuration list based on the QoS flow ID.

In some embodiments, the bearer ID is carried in the header of the SRAP message, such that the target relay bearer configuration is determined in the candidate relay bearer configuration list based on the bearer ID carried in the header of the SRAP.

In some embodiments, the QoS flow ID is carried in the header of the SRAP message, such that the target relay bearer configuration is determined in the candidate relay bearer configuration list based on the QoS flow ID carried in the header of the SRAP.

Exemplarily, the candidate relay bearer configuration list includes at least two candidate relay bearer configurations.

Exemplarily, the candidate relay bearer configurations in the candidate relay bearer configuration list include at least one of the following configurations: a data bearer configuration of a sidelink data radio bearer (SL-DRB); a corresponding relationship between a bearer ID corresponding to the data bearer configuration and first information; an RLC bearer configuration of the SL-DRB; and a corresponding relationship between a bearer ID corresponding to the RLC bearer configuration and the first information, where the first information includes at least one of a QoS flow, a QoS flow list, an RLC bearer configuration index, and an associated bearer configuration index.

Exemplarily, the aforementioned data bearer configuration includes at least one of the following: a related configuration of a Service Data Adaptation Protocol (SDAP) layer; a related configuration of a Packet Data Convergence Protocol (PDCP) layer; and a data bearer configuration index.

Exemplarily, the aforementioned RLC bearer configuration includes at least one of the following: a related configuration of an SRAP layer; a related configuration of an RLC layer; a related configuration of an MAC layer; the RLC bearer configuration index; and the associated bearer configuration index.

In some embodiments, the data bearer configuration of the SL-DRB includes the related configuration of the SDAP layer/PDCP layer, and the RLC bearer configuration includes the related configuration of the SRAP layer/MAC layer/RLC layer. The aforementioned associated bearer configuration index is a bearer configuration index associating the SDAP layer/PDCP layer with the SRAP layer/MAC layer/RLC layer, that is, a set of bearer configurations of a complete protocol stack is associated through the associated bearer configuration index.

In some embodiments, step 240 is preceded by a step of: acquiring the candidate relay bearer configuration list.

Exemplarily, acquiring the candidate relay bearer configuration list, includes at least one of the following modes: acquiring the candidate relay bearer configuration list in a pre-configuration mode; acquiring the candidate relay bearer configuration list by receiving a system broadcast message; acquiring the candidate relay bearer configuration list by receiving radio resource control (RRC)-specific signaling; and acquiring the candidate relay bearer configuration list by receiving a message transmitted by a second terminal.

Exemplarily, acquiring the candidate relay bearer configuration list, includes at least one of the following modes: acquiring the candidate relay bearer configuration list in the pre-configuration mode in the case that the first terminal is out of network coverage; acquiring the candidate relay bearer configuration list by receiving the system broadcast message in the case that the first terminal is in network coverage and in an RRC idle state; acquiring the candidate relay bearer configuration list by receiving the system broadcast message in the case that the first terminal is in network coverage and in an RRC inactive state; acquiring the candidate relay bearer configuration list by receiving the RRC-specific signaling in the case that the first terminal is in network coverage and in an RRC connected state; and acquiring the candidate relay bearer configuration list by receiving a PC5-RRC message or a sidelink medium access control control element (SL-MAC CE) or sidelink control information (SCI) transmitted by the second terminal.

The second terminal is a peer terminal of the first terminal.

In the embodiments of the present disclosure, the second terminal device may be a remote terminal or a relay terminal. Reference can be made to the embodiments shown in FIG. 1 for the meanings of the remote terminal and the relay terminal, which are not repeated herein.

In some embodiments, the first terminal is a source terminal or a remote terminal, and the second terminal is a relay terminal. Alternatively, the first terminal is a relay terminal, and the second terminal is a source terminal or a remote terminal. That is, the relay bearer configuration may be performed from the source terminal/remote terminal to the relay terminal, or the relay bearer configuration may be performed from the relay terminal to the source terminal/remote terminal.

In some embodiments, a first candidate relay bearer configuration list corresponding to a relay service of the first terminal is acquired, where candidate relay bearer configurations in the first candidate relay bearer configuration list include a relay indication; and/or, a second candidate relay bearer configuration list corresponding to a non-relay service of the first terminal is acquired, where candidate relay bearer configurations in the second candidate relay bearer configuration list include a non-relay indication. That is, for the relay service and the non-relay service of the first terminal, the candidate relay bearer configuration lists are acquired separately.

In summary, in the technical solutions according to the embodiments of the present disclosure, the target relay bearer configuration for relay transmission is determined in the candidate relay bearer configuration list based on the information carried in the SRAP message; and D2D relay transmission is implemented by establishing an association mechanism of the information carried in the SRAP message with the target relay bearer configuration.

In some embodiments based on FIG. 2, the information carried in the SRAP message is the bearer ID or the QoS flow ID. Two types of information that may be carried in the aforementioned SRAP message are exemplarily described below.

1) The SRAP message carries the bearer ID.

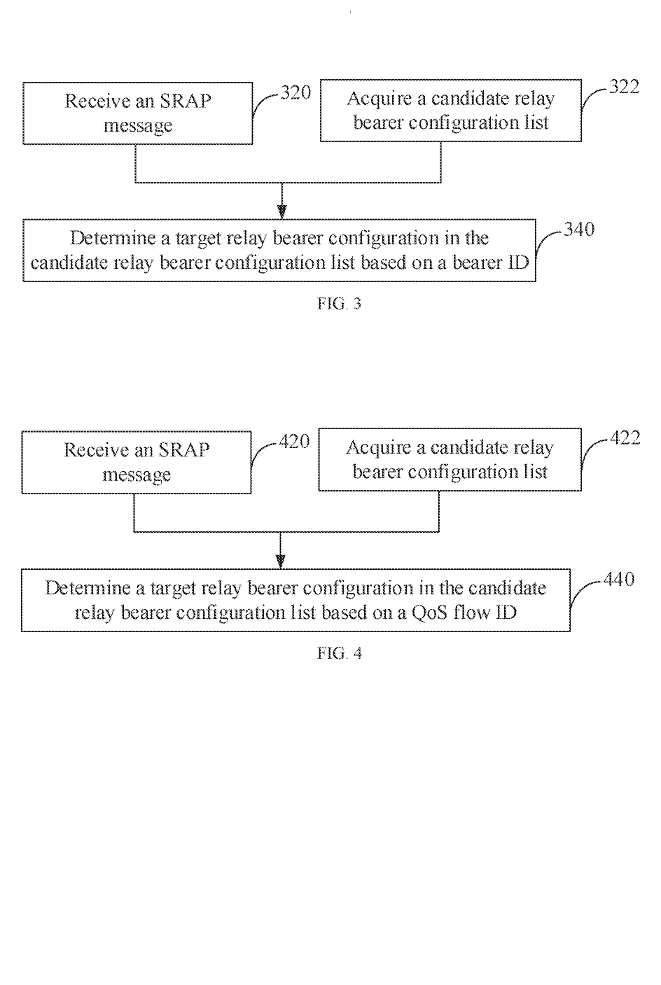

FIG. 3 shows a flowchart of a method for determining a relay bearer configuration according to some embodiments of the present disclosure. The method is applicable to the communication system shown in FIG. 1 and is applicable to a first terminal, which may be the relay terminal 20 or the remote terminal 10 in the communication system shown in FIG. 1. The method includes the following steps:

In step 320, an SRAP message is received.

Exemplarily, the first terminal receives the SRAP message. The SRAP message carries a bearer ID, where the bearer ID is defined to indicate a bearer used by a second terminal for transmitting data to the first terminal.

In some embodiments, the bearer ID is carried in a header of the SRAP message.

The second terminal is a peer terminal of the first terminal.

In the embodiments of the present disclosure, the second terminal device may be a remote terminal or a relay terminal. Reference can be made to the embodiments shown in FIG. 1 for the meanings of the remote terminal and the relay terminal, which are not repeated herein.

In step 322, a candidate relay bearer configuration list is acquired.

Exemplarily, the candidate relay bearer configuration list includes at least two candidate relay bearer configurations.

The candidate relay bearer configurations in the candidate relay bearer configuration list include at least one of the following three configurations:

(1) Configuration 1 is a data bearer configuration of an SL-DRB.

Exemplarily, the data bearer configuration includes at least one of the following:

a related configuration of an SDAP layer;

a related configuration of a PDCP layer; and

a data bearer configuration index.

In some embodiments, a length of the data bearer configuration index is 512 bits.

(2) Configuration 2 is an RLC bearer configuration of the SL-DRB.

Exemplarily, the RLC bearer configuration includes at least one of the following:

a related configuration of an SRAP layer;

a related configuration of an RLC layer;

a related configuration of an MAC layer;

an RLC bearer configuration index; and

an associated bearer configuration index.

In some embodiments, the data bearer configuration of the SL-DRB includes the related configuration of the SDAP layer/PDCP layer, and the RLC bearer configuration includes the related configuration of the SRAP layer/MAC layer/RLC layer. The aforementioned associated bearer configuration index is a bearer configuration index associating the SDAP layer/PDCP layer with the SRAP layer/MAC layer/RLC layer, that is, a set of bearer configurations of a complete protocol stack is associated through the associated bearer configuration index.

(3) Configuration 3 is a corresponding relationship between a bearer ID corresponding to the data bearer configuration and first information; or a corresponding relationship between a bearer ID corresponding to the RLC bearer configuration and the first information.

In some embodiments, the first information includes at least one of a QoS flow, a QoS flow list, an RLC bearer configuration index, and an associated bearer configuration index.

In some embodiments, the bearer ID corresponding to the data bearer configuration is a signaling radio bearer (SRB) ID or a data radio bearer (DRB) ID.

It should be noted that the first terminal may acquire any one of the above three sets of configurations, or any combination of the above three sets of configurations, which is not limited in the present disclosure.

In some embodiments, acquiring the candidate relay bearer configuration list, includes at least one of the following modes: acquiring the candidate relay bearer configuration list in a pre-configuration mode; acquiring the candidate relay bearer configuration list by receiving a system broadcast message; acquiring the candidate relay bearer configuration list by receiving RRC-specific signaling; and acquiring the candidate relay bearer configuration list by receiving a message transmitted by the second terminal.

Further, acquiring the candidate relay bearer configuration list, includes at least one of the following modes:

acquiring the candidate relay bearer configuration list in the pre-configuration mode in the case that the first terminal is out of network coverage;

acquiring the candidate relay bearer configuration list by receiving the system broadcast message in the case that the first terminal is in network coverage and in an RRC idle state;

acquiring the candidate relay bearer configuration list by receiving the system broadcast message in the case that the first terminal is in network coverage and in an RRC inactive state;

acquiring the candidate relay bearer configuration list by receiving the RRC-specific signaling in the case that the first terminal is in network coverage and in an RRC connected state; and

acquiring the candidate relay bearer configuration list by receiving a PC5-RRC message or an SL-MAC CE or SCI transmitted by the second terminal.

The second terminal is a peer terminal of the first terminal.

In the embodiments of the present disclosure, the second terminal device may be a remote terminal or a relay terminal. Reference can be made to the embodiments shown in FIG. 1 for the meanings of the remote terminal and the relay terminal, which are not repeated herein.

That is, the first terminal is a source terminal or a remote terminal, and the second terminal is a relay terminal. Alternatively, the first terminal is a relay terminal, and the second terminal is a source terminal or a remote terminal. That is, the relay bearer configuration may be performed from the source terminal/remote terminal to the relay terminal, or the relay bearer configuration may be performed from the relay terminal to the source terminal/remote terminal.

It should be noted that in Device-to-Device relay transmission, the above three sets of candidate relay bearer configurations may be arbitrarily combined. For example, in the process of transmitting data from the source terminal to the remote terminal via the relay terminal, the source terminal uses the configuration 1 for performing relay bearer configuration to the relay terminal, and the relay terminal uses a combination of the configuration 1 and the configuration 3 for performing relay bearer configuration to the remote terminal, and the like, which is not limited in the present disclosure.

In some embodiments, the first terminal acquires the candidate relay bearer configuration list by receiving the PC5-RRC message/SL-MAC CE/SCI transmitted by the second terminal, and reports candidate relay bearer configurations in the candidate relay bearer configuration list to a network side in the case that the first terminal is in the RRC connected state. The network side may reject the candidate relay bearer configurations reported by the first terminal. In the case that the second terminal receives configuration rejection information from the network side, the second terminal may transmit the configuration rejection information to the first terminal, or transmit a reconfiguration request to the first terminal.

In some embodiments, a first candidate relay bearer configuration list corresponding to a relay service of the first terminal is acquired, where candidate relay bearer configurations in the first candidate relay bearer configuration list include a relay indication; and/or, a second candidate relay bearer configuration list corresponding to a non-relay service of the first terminal is acquired, where candidate relay bearer configurations in the second candidate relay bearer configuration list include a non-relay indication. That is, for the relay service and the non-relay service of the first terminal, the candidate relay bearer configuration lists are acquired separately.

It should be noted that the execution order of step 320 and step 322 is not limited, and step 320 may be executed before step 322; or step 322 may be executed before step 320; or step 320 and step 322 may be executed simultaneously, which is not limited in the present disclosure.

In step 340, a target relay bearer configuration is determined in the candidate relay bearer configuration list based on the bearer ID.

Exemplarily, the candidate relay bearer configuration list includes the bearer ID and specific relay bearer configuration information corresponding to the bearer ID. The first terminal determines the target relay bearer configuration in the candidate relay bearer configuration list based on the bearer ID carried in the SRAP message, that is, the target relay bearer configuration is a relay bearer configuration corresponding to the bearer ID carried in the SRAP message.

Further, the first terminal performs D2D relay transmission based on the target relay bearer configuration.

In summary, in the technical solutions according to the embodiments, the target relay bearer configuration is determined in the candidate relay bearer configuration list acquired by the first terminal based on the bearer ID carried in the SRAP message, such that the D2D relay transmission is implemented.

2) The SRAP message carries the QoS flow ID.

FIG. 4 shows a flowchart of a method for determining a relay bearer configuration according to some embodiments of the present disclosure. The method is applicable to the communication system shown in FIG. 1 and is applicable to a first terminal, which may be the relay terminal 20 or the remote terminal 10 in the communication system shown in FIG. 1. The method includes the following steps:

In step 420, an SRAP message is received.

Exemplarily, the first terminal receives the SRAP message. The SRAP message carries a QoS flow ID, where the QoS flow ID corresponds to a bearer used by a second terminal for transmitting data to the first terminal.

In some embodiments, the QoS flow ID or QoS flow ID list is carried in a header of the SRAP message.

In some embodiments, the QoS flow ID or QoS flow ID list is carried in at least one of the following protocol layer sub-headers: an SRAP layer; an RLC layer; and an MAC layer.

The second terminal is a peer terminal of the first terminal.

In the embodiments of the present disclosure, the second terminal device may be a remote terminal or a relay terminal. Reference can be made to the embodiments shown in FIG. 1 for the meanings of the remote terminal and the relay terminal, which are not repeated herein.

In step 422, a candidate relay bearer configuration list is acquired.

Exemplarily, the candidate relay bearer configuration list includes at least two candidate relay bearer configurations.

In some embodiments, the candidate relay bearer configurations in the candidate relay bearer configuration list include at least one of the following three configurations:

(1) Configuration 1 is a data bearer configuration of an SL-DRB.

Exemplarily, the data bearer configuration includes at least one of the following:

a related configuration of an SDAP layer;

a related configuration of a PDCP layer; and

a data bearer configuration index.

In some embodiments, a length of the data bearer configuration index is 512 bits.

(2) Configuration 2 is an RLC bearer configuration of the SL-DRB.

Exemplarily, the RLC bearer configuration includes at least one of the following:

a related configuration of an SRAP layer;

a related configuration of an RLC layer;

a related configuration of an MAC layer;

an RLC bearer configuration index; and

an associated bearer configuration index.

In some embodiments, the data bearer configuration of the SL-DRB includes the related configuration of the SDAP layer/PDCP layer, and the RLC bearer configuration includes the related configuration of the SRAP layer/MAC layer/RLC layer. The aforementioned associated bearer configuration index is a bearer configuration index associating the SDAP layer/PDCP layer with the SRAP layer/MAC layer/RLC layer, that is, a set of bearer configurations of a complete protocol stack is associated through the associated bearer configuration index.

(3) Configuration 3 is a corresponding relationship between a bearer ID corresponding to the data bearer configuration and first information; or a corresponding relationship between a bearer ID corresponding to the RLC bearer configuration and the first information.

In some embodiments, the first information includes at least one of a QoS flow, a QoS flow list, an RLC bearer configuration index, and an associated bearer configuration index.

In some embodiments, the bearer ID corresponding to the data bearer configuration is a signaling radio bearer (SRB) ID or a data radio bearer (DRB) ID.

It should be noted that the first terminal may acquire any one of the above three sets of configurations, or any combination of the above three sets of configurations, which is not limited in the present disclosure.

In some embodiments, acquiring the candidate relay bearer configuration list, includes at least one of the following modes: acquiring the candidate relay bearer configuration list in a pre-configuration mode; acquiring the candidate relay bearer configuration list by receiving a system broadcast message; acquiring the candidate relay bearer configuration list by receiving RRC-specific signaling; and acquiring the candidate relay bearer configuration list by receiving a message transmitted by the second terminal.

Exemplarily, acquiring the candidate relay bearer configuration list, includes at least one of the following modes:

acquiring the candidate relay bearer configuration list in the pre-configuration mode in the case that the first terminal is out of network coverage;

acquiring the candidate relay bearer configuration list by receiving the system broadcast message in the case that the first terminal is in network coverage and in an RRC idle state;

acquiring the candidate relay bearer configuration list by receiving the system broadcast message in the case that the first terminal is in network coverage and in an RRC inactive state;

acquiring the candidate relay bearer configuration list by receiving the RRC-specific signaling in the case that the first terminal is in network coverage and in an RRC connected state; and

acquiring the candidate relay bearer configuration list by receiving a PC5-RRC message or an SL-MAC CE or SCI transmitted by the second terminal.

The second terminal is a peer terminal of the first terminal.

In the embodiments of the present disclosure, the second terminal device may be a remote terminal or a relay terminal. Reference can be made to the embodiments shown in FIG. 1 for the meanings of the remote terminal and the relay terminal, which are not repeated herein.

That is, the first terminal is a source terminal or a remote terminal, and the second terminal is a relay terminal. Alternatively, the first terminal is a relay terminal, and the second terminal is a source terminal or a remote terminal. That is, the relay bearer configuration may be performed from the source terminal/remote terminal to the relay terminal, or the relay bearer configuration may be performed from the relay terminal to the source terminal/remote terminal.

In some embodiments, the first terminal acquires the candidate relay bearer configuration list by receiving the PC5-RRC message/SL-MAC CE/SCI transmitted by the second terminal, and reports candidate relay bearer configurations in the candidate relay bearer configuration list to a network side in the case that the first terminal is in the RRC connected state. The network side may reject the candidate relay bearer configurations reported by the first terminal. In the case that the second terminal receives configuration rejection information from the network side, the second terminal may transmit the configuration rejection information to the first terminal, or transmit a reconfiguration request to the first terminal.

In some embodiments, a first candidate relay bearer configuration list corresponding to a relay service of the first terminal is acquired, where candidate relay bearer configurations in the first candidate relay bearer configuration list include a relay indication; and/or, a second candidate relay bearer configuration list corresponding to a non-relay service of the first terminal is acquired, where candidate relay bearer configurations in the second candidate relay bearer configuration list include a non-relay indication. That is, for the relay service and the non-relay service of the first terminal, the candidate relay bearer configuration lists are acquired separately.

In some embodiments, the second terminal generates a D2D bearer configuration sequence based on the QoS flow IDs and the RLC bearer configurations. That is, the D2D bearer configuration sequence is a UE-to-UE bearer configuration sequence generated by the second terminal based on the QoS flow IDs and an RLC bearer configuration sequence.

Exemplarily, the second terminal further serializes the QoS flow IDs and the RLC bearer configuration sequence to generate the D2D bearer configuration sequence. A serialization rule is to combine the QoS flow IDs with the RLC bearer configurations corresponding to the QoS flow IDs to generate the D2D bearer configuration sequence, where labels of the D2D bearer configuration sequence are in one-to-one correspondence to the QoS flow IDs.

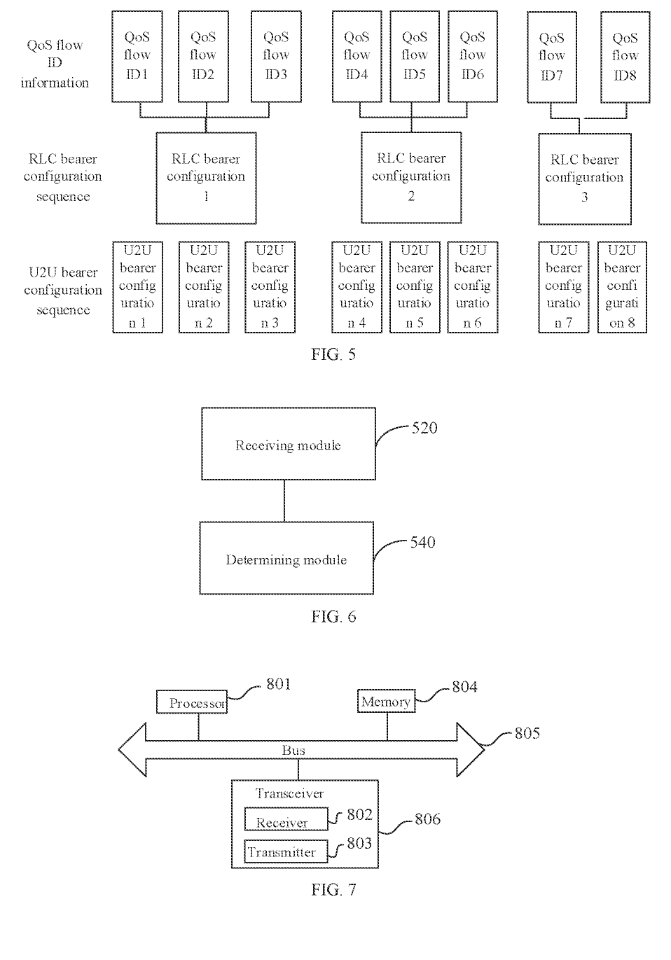

FIG. 5 shows a schematic diagram of a serialization rule for generating a D2D bearer configuration sequence. As shown, QoS flow ID 1, QoS flow ID 2, and QoS flow ID 3 correspond to RLC bearer configuration 1; QoS flow ID 4, QoS flow ID 5, and QoS flow ID 6 correspond to RLC bearer configuration 2; and QoS flow ID 7 and QoS flow ID 8 correspond to RLC bearer configuration 3. The present disclosure does not limit the corresponding manner of the QoS flow IDs with the RLC bearer configurations.

In the serialization process, for example, QoS flow ID 1 is combined with corresponding RLC bearer configuration 1 to generate D2D bearer configuration 1; for another example, QoS flow ID 2 is combined with corresponding RLC bearer configuration 1 to generate D2D bearer configuration 2; and for yet another example, QoS flow ID 4 is combined with corresponding RLC bearer configuration 2 to generate D2D bearer configuration 4, and so on.

In some embodiments, the above D2D bearer configuration sequence is carried in at least one of the following protocol layer sub-headers: an SRAP layer; an RLC layer; and a MAC layer.

It should be noted that the execution order of step 420 and step 422 is not limited, and step 420 may be executed before step 422; or step 422 may be executed before step 420; or step 420 and step 422 may be executed simultaneously, which is not limited in the present disclosure.

In step 440, a target relay bearer configuration is determined in the candidate relay bearer configuration list based on the QoS flow ID.

Exemplarily, the candidate relay bearer configuration list includes candidate relay bearers and specific relay bearer configuration information corresponding to the candidate relay bearers. The first terminal determines the target relay bearer configuration in the candidate relay bearer configuration list based on the QoS flow ID which is carried in the SRAP message and corresponds to the relay bearer used for the current relay transmission.

Further, the first terminal performs D2D relay transmission based on the target relay bearer configuration.

In some embodiments, in the case that the second terminal generates the D2D bearer configuration sequence based on the QoS flow ID and the RLC bearer configuration, the target relay bearer configuration is determined based on the QoS flow ID and the D2D bearer configuration sequence. For example, referring to FIG. 5, in the case that the QoS flow ID indicates QoS flow ID5, i.e., the QoS flow ID corresponds to D2D bearer configuration 5, the first terminal determines RLC bearer configuration 2 corresponding to D2D bearer configuration 5 as the target relay bearer configuration.

It should be noted that in Device-to-Device relay transmission, the aforementioned candidate relay bearer configuration list may be generated through any combination. For example, in the process of transmitting data from the source terminal to the remote terminal via the relay terminal, the source terminal uses the configuration 1 for performing relay bearer configuration to the relay terminal, and the relay terminal uses a combination of the configuration 1, the configuration 2, and the configuration 3 for performing relay bearer configuration to the remote terminal. For another example, the source terminal uses the configuration 2 for performing relay bearer configuration to the relay terminal, and the relay terminal uses the above D2D bearer configuration sequence for performing relay bearer configuration to the remote terminal. For yet another example, the source terminal uses the above D2D bearer configuration sequence for performing relay bearer configuration to the relay terminal and the relay terminal uses the above D2D bearer configuration sequence for performing relay bearer configuration to the remote terminal, and the like, which is not limited in the present disclosure.

In summary, in the technical solutions according to the embodiments, the target relay bearer configuration is determined in the candidate relay bearer configuration list acquired by the first terminal based on the QoS flow ID carried in the SRAP message, such that the D2D relay transmission is implemented.

The following is an apparatus embodiment of the present disclosure that may be configured to implement the method embodiments of the present disclosure. For details that are not disclosed in the apparatus embodiment of the present disclosure, reference is made to the method embodiments of the present disclosure.

FIG. 6 shows a structural block diagram of an apparatus for determining a relay bearer configuration according to some embodiments of the present disclosure. The apparatus has functions for implementing the above method examples of the first terminal, and the functions can be implemented by hardware, or by hardware executing corresponding software. The apparatus may be the first terminal described above, or may be provided in the first terminal. As shown in FIG. 6, the apparatus includes the following modules:

a receiving module 520, configured to receive a Sidelink Relay Adaptation Protocol (SRAP) message; and

a determining module 540, configured to determine a target relay bearer configuration in a candidate relay bearer configuration list based on the SRAP message.

In some embodiments, the SRAP message carries: a bearer identifier (ID); or, a quality of service (QoS) flow ID.

In some embodiments, the target relay bearer configuration is determined in the candidate relay bearer configuration list based on the bearer ID.

In some embodiments, the target relay bearer configuration is determined in the candidate relay bearer configuration list based on the QoS flow ID.

In some embodiments, the receiving module 520 is further configured to acquire the candidate relay bearer configuration list.

In some embodiments, candidate relay bearer configurations in the candidate relay bearer configuration list include at least one of the following configurations: a data bearer configuration of a sidelink data radio bearer (SL-DRB); a corresponding relationship between a bearer ID corresponding to the data bearer configuration and first information; a radio link control (RLC) bearer configuration of the SL-DRB; and a corresponding relationship between a bearer ID corresponding to the RLC bearer configuration and the first information, where the first information includes at least one of a QoS flow, a QoS flow list, an RLC bearer configuration index, or an associated bearer configuration index.

In some embodiments, the data bearer configuration includes at least one of the following: a related configuration of a Service Data Adaptation Protocol (SDAP) layer; a related configuration of a Packet Data Convergence Protocol (PDCP) layer; and a data bearer configuration index.

In some embodiments, the RLC bearer configuration includes at least one of the following: a related configuration of an SRAP layer; a related configuration of an RLC layer; a related configuration of a medium access control (MAC) layer; the RLC bearer configuration index; or the associated bearer configuration index.

In some embodiments, the receiving module 520 is further configured to perform at least one of the following: acquiring the candidate relay bearer configuration list in a pre-configuration mode; acquiring the candidate relay bearer configuration list by receiving a system broadcast message; acquiring the candidate relay bearer configuration list by receiving radio resource control (RRC)-specific signaling; and acquiring the candidate relay bearer configuration list by receiving a message transmitted by a second terminal.

In some embodiments, the receiving module 520 is further configured to perform at least one of the following: acquiring the candidate relay bearer configuration list in the pre-configuration mode in the case that the first terminal is out of network coverage; acquiring the candidate relay bearer configuration list by receiving the system broadcast message in the case that the first terminal is in network coverage and in a radio resource control (RRC) idle state; acquiring the candidate relay bearer configuration list by receiving the system broadcast message in the case that the first terminal is in network coverage and in a radio resource control (RRC) inactive state; acquiring the candidate relay bearer configuration list by receiving the RRC-specific signaling in the case that the first terminal is in network coverage and in a radio resource control (RRC) connected state; and acquiring the candidate relay bearer configuration list by receiving a PC5-RRC message or a sidelink medium access control (SL-MAC) control element (CE) or sidelink control information (SCI) transmitted by the second terminal.

In some embodiments, the first terminal is a source terminal or a remote terminal, and the second terminal is a relay terminal; or, the first terminal is a relay terminal, and the second terminal is a source terminal or a remote terminal.

In some embodiments, the receiving module 520 is further configured to acquire a first candidate relay bearer configuration list corresponding to a relay service of the first terminal, where the first candidate relay bearer configuration list includes a relay indication; and/or, acquire a second candidate relay bearer configuration list corresponding to a non-relay service of the first terminal, where the second candidate relay bearer configuration list includes a non-relay indication.

In some embodiments, the QoS flow ID is carried in at least one of the following protocol layer sub-headers: an SRAP layer; an RLC layer; and an MAC layer.

In some embodiments, the target relay bearer configuration is determined based on the QoS flow ID and a UE-to-UE (D2D) bearer configuration sequence, and the D2D bearer configuration sequence is a Device-to-Device bearer configuration sequence generated by the second terminal based on the QoS flow ID and an RLC bearer configuration sequence.

In some embodiments, the D2D bearer configuration sequence is carried in at least one of the following protocol layer sub-headers: an SRAP layer; an RLC layer; and an MAC layer.

It should be noted that, in the case that the apparatus according to the above embodiments implements the functions thereof, the division of the functional modules is merely exemplary. In practical application, the above functions may be assigned to different functional modules according to actual needs, i.e., the internal structure of the device may be divided into different functional modules, such that all or a part of the above functions are implemented.

With regard to the apparatus in the above embodiments, the specific manner in which each module performs the operation has been described in detail in the embodiments related to the method and will not be described in detail herein.

Referring to FIG. 7, a schematic structural diagram of a terminal device according to some embodiments of the present disclosure is shown. The terminal device includes a processor 801, a receiver 802, a transmitter 803, a memory 804, and a bus 805.

The processor 801 includes one or more processing cores, and the processor 801 performs various functional applications and information processing by running software programs and modules.

The receiver 802 and the transmitter 803 are implemented as one transceiver 806, and the transceiver 806 is one communication chip.

The memory 804 is connected to the processor 801 via the bus 805.

The memory 804 is configured to store a computer program, and the processor 801 is configured to run the computer program to implement the various steps executed by the terminal device in the above method embodiments.

Furthermore, the memory 804 is implemented by any type or a combination of volatile or non-volatile storage devices, including, but not limited to: a random-access memory (RAM) and a read-only memory (ROM), an erasable programmable read-only memory (EPROM), an electrically erasable programmable read-only memory (EEPROM), a flash memory or other solid-state memory technologies, a compact disc read-only memory (CD-ROM), a digital video disc (DVD) or other optical storage, a magnetic cassette, a magnetic tape, magnetic disk storage, or other magnetic storage devices.

In the case that the terminal device is implemented as a first terminal device, the processor and the transceiver described in the embodiments of the present disclosure may execute the steps executed by the first terminal in the method as shown in any one of FIGS. 2 to 4, which are not repeated herein.

In some embodiments, in the case that the terminal device is implemented as the first terminal device,

the receiver 802 is configured to receive an SRAP message; and

the processor 801 is configured to determine a target relay bearer configuration in a candidate relay bearer configuration list based on the SRAP message.

The embodiments of the present disclosure further provide a computer-readable storage medium storing one or more computer programs, where the one or more computer programs, when run by a processor of a first terminal, cause the processor to perform the above method for determining a relay bearer configuration of the first terminal.

In some embodiments, the computer-readable storage medium includes: a read-only memory (ROM), a random-access memory (RAM), a solid state drive (SSD), an optical disk, or the like. The RAM includes a resistance random-access memory (ReRAM) and a dynamic random-access memory (DRAM).

The embodiments of the present disclosure further provide a chip including one or more programmable logic circuits and/or one or more program instructions, where the chip, when running on a first terminal, is caused to perform the above method for determining a relay bearer configuration of the first terminal.

The embodiments of the present disclosure further provide a computer program product or computer program including one or more computer instructions stored in a computer-readable storage medium, where the one or more computer instructions, when read from the computer-readable storage medium and executed by a processor of a first terminal, cause the processor to perform the above method for determining a relay bearer configuration of the first terminal.

It should be understood that the "indication" mentioned in the embodiments of the present disclosure is a direct indication, an indirect indication, or an indication that there is an association relationship. For example, "A indicates B" may mean that A indicates B directly, e.g., B may be acquired through A; or that A indicates B indirectly, e.g., A indicates C through which B may be acquired; or that an association relationship is present between A and B.

In the description of the embodiments of the present disclosure, the term "correspond" indicates a direct or indirect corresponding relationship between two items, or indicates an association relationship between the two. It may also indicate relationships such as indicating and being indicated, and configuring and being configured.

The mentioned term "multiple" herein means two or more. The term "and/or" describes the association relationship of the associated objects, and indicates that three relationships may be present. For example, A and/or B may indicate that: only A is present, both A and B are present, and only B is present. The symbol "/" generally indicates an "or" relationship between the associated objects.

In addition, serial numbers of the steps described herein only show an exemplary possible execution sequence among the steps, and in some other embodiments, the steps may also be executed out of the numbering sequence, for example, two steps with different serial numbers are executed simultaneously, or two steps with different serial numbers are executed in a reverse order to the illustrated sequence, which is not limited in the present disclosure.

Those skilled in the art should appreciate that in the one or more examples mentioned above, the functions described in the embodiments of the present disclosure may be implemented using hardware, software, firmware, or any combination thereof. The functions, when implemented using software, are stored in a computer-readable medium or transmitted as one or more instructions or codes on the computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, etc., made within the spirit and principle of the present disclosure should fall within the protection scope of the present disclosure.

1. A method for determining a relay bearer configuration, applicable to a first terminal, the method comprising:
receiving a Sidelink Relay Adaptation Protocol (SRAP) message; and
determining a target relay bearer configuration in a candidate relay bearer configuration list based on the SRAP message.

2. The method according to claim 1, wherein the SRAP message carries:
a bearer identifier (ID).

3. The method according to claim 2, wherein the target relay bearer configuration is determined in the candidate relay bearer configuration list based on the bearer ID.

4. The method according to claim 1, further comprising:
acquiring the candidate relay bearer configuration list.

5. The method according to claim 1, wherein candidate relay bearer configurations in the candidate relay bearer configuration list comprise at least one of:
a data bearer configuration of a sidelink data radio bearer (SL-DRB);
a corresponding relationship between a bearer ID corresponding to a data bearer configuration and first information;
a radio link control (RLC) bearer configuration of the SL-DRB; or
a corresponding relationship between a bearer ID corresponding to an RLC bearer configuration and first information,
wherein the first information comprises at least one of a quality of service (QoS) flow, a QoS flow list, an RLC bearer configuration index, or an associated bearer configuration index.

6. The method according to claim 5, wherein the data bearer configuration comprises at least one of:
a related configuration of a Service Data Adaptation Protocol (SDAP) layer; or
a data bearer configuration index.

7. The method according to claim 5, wherein the RLC bearer configuration comprises at least one of:
a related configuration of an SRAP layer;
a related configuration of an RLC layer;
a related configuration of a medium access control (MAC) layer;
the RLC bearer configuration index; or
the associated bearer configuration index.

8. The method according to claim 4, wherein acquiring the candidate relay bearer configuration list comprises at least one of:
acquiring the candidate relay bearer configuration list in a pre-configuration mode;
acquiring the candidate relay bearer configuration list by receiving a system broadcast message;
acquiring the candidate relay bearer configuration list by receiving radio resource control (RRC)-specific signaling; or
acquiring the candidate relay bearer configuration list by receiving a message transmitted by a second terminal.

9. The method according to claim 8, wherein acquiring the candidate relay bearer configuration list comprises at least one of:
acquiring the candidate relay bearer configuration list in the pre-configuration mode in a case that the first terminal is out of network coverage;
acquiring the candidate relay bearer configuration list by receiving the system broadcast message in a case that the first terminal is in network coverage and in a radio resource control (RRC) idle state;
acquiring the candidate relay bearer configuration list by receiving the system broadcast message in a case that the first terminal is in network coverage and in an RRC inactive state;
acquiring the candidate relay bearer configuration list by receiving the RRC-specific signaling in a case that the first terminal is in network coverage and in an RRC connected state; or
acquiring the candidate relay bearer configuration list by receiving a PC5-RRC message, a sidelink medium access control (SL-MAC) control element (CE), or sidelink control information (SCI) from the second terminal.

10. The method according to claim 8, wherein
the first terminal is a source terminal or a remote terminal, and the second terminal is a relay terminal; or
the first terminal is a relay terminal, and the second terminal is a source terminal or a remote terminal.

11. The method according to claim 4, wherein acquiring the candidate relay bearer configuration list further comprises at least one of:
acquiring a first candidate relay bearer configuration list corresponding to a relay service of the first terminal, wherein candidate relay bearer configurations in the first candidate relay bearer configuration list comprise a relay indication; or
acquiring a second candidate relay bearer configuration list corresponding to a non-relay service of the first terminal, wherein candidate relay bearer configurations in the second candidate relay bearer configuration list comprise a non-relay indication.

12. A terminal device, comprising a transceiver and a processor; wherein
the transceiver is configured to receive a Sidelink Relay Adaptation Protocol (SRAP) message; and
the processor is configured to determine a target relay bearer configuration in a candidate relay bearer configuration list based on the SRAP message.

13. The terminal device according to claim 12, wherein the SRAP message carries:
a bearer identifier (ID).

14. The terminal device according to claim 13, wherein the target relay bearer configuration is determined in the candidate relay bearer configuration list based on the bearer ID.

15. The terminal device according to claim 12, wherein the transceiver is further configured to:
acquire the candidate relay bearer configuration list.

16. The terminal device according to claim 12, wherein candidate relay bearer configurations in the candidate relay bearer configuration list comprise at least one of:
a data bearer configuration of a sidelink data radio bearer (SL-DRB);
a corresponding relationship between a bearer ID corresponding to a data bearer configuration and first information;
a radio link control (RLC) bearer configuration of the SL-DRB; or
a corresponding relationship between a bearer ID corresponding to an RLC bearer configuration and first information,
wherein the first information comprises at least one of a quality of service (QoS) flow, a QoS flow list, an RLC bearer configuration index, or an associated bearer configuration index.

17. The terminal device according to claim 16, wherein the data bearer configuration comprises at least one of:
a related configuration of a Service Data Adaptation Protocol (SDAP) layer; or
a data bearer configuration index.

18. The terminal device according to claim 16, wherein the RLC bearer configuration comprises at least one of:
a related configuration of an SRAP layer;
a related configuration of an RLC layer;
a related configuration of a medium access control (MAC) layer;
the RLC bearer configuration index; or
the associated bearer configuration index.

19. The terminal device according to claim 15, wherein the transceiver is further configured to at least one of:
acquire the candidate relay bearer configuration list in a pre-configuration mode;
acquire the candidate relay bearer configuration list by receiving a system broadcast message;
acquire the candidate relay bearer configuration list by receiving radio resource control (RRC)-specific signaling; or
acquire the candidate relay bearer configuration list by receiving a message transmitted by a second terminal.

20. The terminal device according to claim 15, wherein the transceiver is further configured to at least one of:
acquire a first candidate relay bearer configuration list corresponding to a relay service of the first terminal, wherein candidate relay bearer configurations in the first candidate relay bearer configuration list comprise a relay indication; or
acquire a second candidate relay bearer configuration list corresponding to a non-relay service of the first terminal, wherein candidate relay bearer configurations in the second candidate relay bearer configuration list comprise a non-relay indication.
